(19) United States
(12) Patent Application Publication
(10) Pub. No.: US 2026/0311619 A1
(43) Pub. Date: Oct. 8, 2026

(54) CHEST MOTION EMULATOR

(71) Applicant: THE ALFRED E. MANN FOUNDATION FOR SCIENTIFIC RESEARCH, Valencia, CA (US)

(72) Inventors: Rankiri Tissa KARUNASIRI, Valencia, CA (US); Fernando ÁVILA, Castaic, CA (US)

(21) Appl. No.: 19/711,894

(22) Filed: Jun. 17, 2026

Related U.S. Application Data
(63) Continuation-in-part of application No. 19/562,750, filed on Mar. 10, 2026.
(60) Provisional application No. 63/770,308, filed on Mar. 11, 2025.

(51) Int. Cl. G09B 23/30

(52) U.S. Cl. CPC G09B 23/30

(57) ABSTRACT

According to an embodiment of the present disclosure, there is provided a system, including: a chest motion emulator, including: an actuator, including: a movable platform for a device under test; a shaft having an eccentric portion; and a motor, directly coupled to the shaft and configured to cause the shaft to turn, the eccentric portion being configured to cause the platform to move in response to rotation of the motor.

### CROSS-REFERENCE TO RELATED APPLICATION(S)

The present application is a continuation-in-part of U.S. patent application Ser. No. 19/562,750, filed Mar. 10, 2026, entitled “CHEST MOTION EMULATOR”, which claims priority to and the benefit of U.S. Provisional Application No. 63/770,308, filed Mar. 11, 2025, entitled “CHEST MOTION EMULATOR”; the entire contents of all of the documents identified in this paragraph are incorporated herein by reference.

### FIELD

One or more aspects of embodiments according to the present disclosure relate to motion-sensing devices, and more particularly to a chest motion emulator for testing such devices.

### BACKGROUND

Various kinds of medical devices may monitor breathing and cardiac activity by monitoring the associated motions of the chest. Such devices may be tested during design, manufacturing, or service.

It is with respect to this general technical environment that aspects of the present disclosure are related.

### SUMMARY

According to an embodiment of the present disclosure, there is provided a system including: a chest motion emulator, including: a first linear actuator, the first linear actuator being configured to support a device under test.

In some embodiments, the first linear actuator includes a voice coil actuator.

In some embodiments, the first linear actuator includes a loudspeaker.

In some embodiments, the loudspeaker includes a cone including a mounting hole for securing the device under test.

In some embodiments, the chest motion emulator further includes a drive amplifier connected to the first linear actuator.

In some embodiments, the drive amplifier is DC-coupled.

In some embodiments, the drive amplifier is a class D amplifier.

In some embodiments, the combination of the drive amplifier and the first linear actuator has a passband including a frequency range extending from 1 Hz to 5 Hz.

In some embodiments, the combination of the drive amplifier and the first linear actuator has a passband including a frequency range extending from 0.1 Hz to 5 Hz.

In some embodiments, the system further includes a second linear actuator, wherein the first linear actuator and the second linear actuator are configured to produce motion, of the device under test, in a first degree of freedom and in a second degree of freedom.

In some embodiments, the first degree of freedom is a first translational degree of freedom and the second degree of freedom is a second translational degree of freedom, different from the first translational degree of freedom.

In some embodiments, the first degree of freedom is a translational degree of freedom and the second degree of freedom is a rotational degree of freedom.

In some embodiments: the chest motion emulator is capable of emulating chest motion of a subject, and the chest motion includes motion caused by breathing.

In some embodiments, the chest motion further includes motion caused by a heartbeat.

In some embodiments, the chest motion further includes noise motion.

In some embodiments, the noise motion includes non-breathing skeletal muscle motion.

In some embodiments, the noise motion includes digestive motion.

According to an embodiment of the present disclosure, there is provided a system including: a first loudspeaker; and a drive circuit, the drive circuit being configured to cause the first loudspeaker to move in a manner emulating chest motion of a subject.

In some embodiments, the first loudspeaker is configured to support a device under test.

In some embodiments, the first loudspeaker includes a cone having a flat portion suitable for supporting the device under test.

In some embodiments, the cone includes a mounting hole for securing the device under test.

In some embodiments, the drive circuit includes a drive amplifier connected to the first loudspeaker.

In some embodiments, the drive amplifier is DC-coupled.

In some embodiments, the drive amplifier is a class D amplifier.

In some embodiments, the combination of the drive amplifier and the first loudspeaker has a passband including a frequency range extending from 1 Hz to 5 Hz.

In some embodiments, the combination of the drive amplifier and the first loudspeaker has a passband including a frequency range extending from 0.1 Hz to 5 Hz.

In some embodiments, the system further includes a second loudspeaker, wherein the first loudspeaker and the second loudspeaker are configured to produce motion, of a device under test, in a first degree of freedom and in a second degree of freedom.

In some embodiments, the first degree of freedom is a first translational degree of freedom and the second degree of freedom is a second translational degree of freedom, different from the first translational degree of freedom.

In some embodiments, the first degree of freedom is a translational degree of freedom and the second degree of freedom is a rotational degree of freedom.

In some embodiments, the first loudspeaker is capable of emulating motion caused by breathing and motion caused by a heartbeat.

In some embodiments, the first loudspeaker is further capable of emulating noise motion.

In some embodiments, the chest motion includes motion caused by breathing.

In some embodiments, the chest motion further includes motion caused by a heartbeat.

In some embodiments, the chest motion further includes noise motion.

In some embodiments, the noise motion includes non-breathing skeletal muscle motion.

In some embodiments, the noise motion includes digestive motion.

In some embodiments, the drive circuit is capable of causing a voice coil of the first loudspeaker to move at least 5 mm at any frequency between 1 Hz and 5 Hz.

According to an embodiment of the present disclosure, there is provided a system including: a chest motion emulator, including: a first linear actuator, and a drive amplifier for driving the first linear actuator, the drive amplifier being direct-current coupled (DC-coupled).

In some embodiments, the first linear actuator includes a voice coil actuator.

In some embodiments, the first linear actuator includes a loudspeaker.

In some embodiments, the loudspeaker includes a cone including a mounting hole for securing a device under test.

In some embodiments, the drive amplifier is a class D amplifier.

In some embodiments, the combination of the drive amplifier and the first linear actuator has a passband including a frequency range extending from 1 Hz to 5 Hz.

In some embodiments, the combination of the drive amplifier and the first linear actuator has a passband including a frequency range extending from 0.1 Hz to 5 Hz.

In some embodiments, the system further includes a second linear actuator, wherein the first linear actuator and the second linear actuator are configured to produce motion, of a device under test, in a first degree of freedom and in a second degree of freedom.

In some embodiments, the first degree of freedom is a first translational degree of freedom and the second degree of freedom is a second translational degree of freedom, different from the first translational degree of freedom.

In some embodiments, the first degree of freedom is a translational degree of freedom and the second degree of freedom is a rotational degree of freedom.

In some embodiments: the chest motion emulator is capable of emulating chest motion, and the chest motion includes motion caused by breathing.

In some embodiments, the chest motion further includes motion caused by a heartbeat.

In some embodiments, the chest motion further includes noise motion.

In some embodiments, the noise motion includes non-breathing skeletal muscle motion.

In some embodiments, the noise motion includes digestive motion.

According to an embodiment of the present disclosure, there is provided a method, including: generating emulated motion, by a chest motion emulator, the emulated motion emulating chest motion of a subject, the chest motion emulator including: a loudspeaker; and a drive circuit.

In some embodiments, the chest motion includes motion caused by breathing.

In some embodiments, the chest motion further includes motion caused by a heartbeat.

In some embodiments, the chest motion further includes noise motion.

In some embodiments, the noise motion includes non-breathing skeletal muscle motion.

In some embodiments, the noise motion includes digestive motion.

In some embodiments, the generating of the motion includes: generating a target motion profile; generating a drive signal based on the target motion profile; and applying the drive signal to the loudspeaker.

In some embodiments, the generating of the target motion profile includes: generating a recorded chest motion signal by recording a signal from a motion sensor secured to the chest of a subject; and modifying the recorded chest motion signal.

According to an embodiment of the present disclosure, there is provided a system, including: a chest motion emulator, including: an actuator, including: a movable platform for a device under test; a shaft having an eccentric portion; and a motor, directly coupled to the shaft and configured to cause the shaft to turn, the eccentric portion being configured to cause the platform to move in response to rotation of the motor.

In some embodiments: the actuator further includes a first flexible element; and the movable platform is supported by the first flexible element.

In some embodiments, the first flexible element is a spring, supporting the movable platform from below.

In some embodiments, the first flexible element is a spring, supporting the movable platform from above.

In some embodiments: the first flexible element is a first spring, and the actuator includes a plurality of springs including the first spring.

In some embodiments, the first spring is secured to a lower portion of the movable platform and a second spring of the plurality of springs is secured to an upper portion of the movable platform.

In some embodiments, the plurality of springs includes: four lower springs, including the first spring, secured to the lower portion of the movable platform; and four upper springs, including the second spring, secured to the upper portion of the movable platform.

In some embodiments: the actuator further includes a frame; and each of the springs is further secured to the frame.

In some embodiments, the frame includes: a top plate; a bottom plate; and a plurality of posts securing the top plate to the bottom plate.

In some embodiments, the movable platform is a movable plate.

In some embodiments, the movable plate is composed of an organic polymer.

In some embodiments, the eccentric portion is a cam, secured to the shaft.

In some embodiments, the eccentric portion is an offset portion of the shaft.

In some embodiments, the chest motion emulator further includes a drive circuit connected to the motor.

In some embodiments, the combination of the drive circuit and the actuator has a passband including a frequency range extending from 0.2 Hz to 0.3 Hz.

In some embodiments, the motor is a servomotor.

In some embodiments: the chest motion emulator is capable of emulating chest motion of a subject, and the chest motion includes motion caused by breathing.

In some embodiments, the chest motion further includes motion caused by a heartbeat.

In some embodiments, the chest motion further includes noise motion.

In some embodiments, the noise motion includes non-breathing skeletal muscle motion.

In some embodiments, the noise motion includes digestive motion.

In some embodiments, the device under test is an implantable pulse generator.

According to an embodiment of the present disclosure, there is provided a method, including: generating emulated motion, by a chest motion emulator, the emulated motion emulating chest motion of a subject, the chest motion emulator including: an actuator, including: a movable platform for a device under test; a shaft having an eccentric portion; and a motor, directly coupled to the shaft and configured to cause the shaft to turn, the eccentric portion being configured to cause the platform to move in response to rotation of the motor.

In some embodiments, the chest motion includes motion caused by breathing.

In some embodiments, the chest motion further includes motion caused by a heartbeat.

In some embodiments, the chest motion further includes noise motion.

In some embodiments, the noise motion includes non-breathing skeletal muscle motion.

In some embodiments, the noise motion includes digestive motion.

In some embodiments, the generating of the emulated motion includes: generating a target motion profile; generating a drive signal based on the target motion profile; and applying the drive signal to the actuator.

In some embodiments, the generating of the target motion profile includes: generating a recorded chest motion signal by recording a signal from a motion sensor secured to the chest of a subject; and modifying the recorded chest motion signal.

### BRIEF DESCRIPTION OF THE DRAWINGS

These and other features and advantages of the present disclosure will be appreciated and understood with reference to the specification, claims, and appended drawings wherein:

FIG. 1A is a block diagram of a portion of a chest motion emulator, according to an embodiment of the present disclosure;

FIG. 1B is a schematic drawing of a portion of a chest motion emulator, according to an embodiment of the present disclosure;

FIG. 1C is a block diagram of a portion of a chest motion emulator, according to an embodiment of the present disclosure;

FIG. 2A is a perspective drawing of a portion of a chest motion emulator, according to an embodiment of the present disclosure;

FIG. 2B is a perspective drawing of a portion of a chest motion emulator, according to an embodiment of the present disclosure;

FIG. 3 is a flow chart of a method for operating a chest motion emulator, according to an embodiment of the present disclosure;

FIG. 4A is a perspective drawing of an actuator, according to an embodiment of the present disclosure;

FIG. 4B is a drawing of an actuator shaft with an offset portion, according to an embodiment of the present disclosure;

FIG. 4C is an end view of an actuator shaft with a cam, according to an embodiment of the present disclosure;

FIG. 4D is a side view of an actuator shaft with a cam, according to an embodiment of the present disclosure; and

FIG. 5 is a block diagram of a controller and a motor, according to an embodiment of the present disclosure.

### DETAILED DESCRIPTION

The detailed description set forth below in connection with the appended drawings is intended as a description of exemplary embodiments of a chest motion emulator and associated methods provided in accordance with the present disclosure and is not intended to represent the only forms in which the present disclosure may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features.

Embodiments described in this disclosure pertain to motion-sensing devices, specifically focusing on a chest motion emulator that is utilized for testing these devices. The chest motion emulator is designed to simulate physiological movements, allowing for comprehensive evaluation and characterization of motion-sensing devices under controlled conditions.

Medical devices having sensors for monitoring chest motion have various applications, including monitoring breathing or heartbeat. Such devices may include motion sensors, e.g., inertial sensors, such as gyroscopes, magnetometers, or accelerometers.

During the design, manufacturing, or servicing of such a device, it may be advantageous to test the operation and accuracy of the device. Such testing may be performed using a live test subject (e.g., a human subject) in a lab environment, but this method may be costly or impractical, e.g., during device development, when testing may be required for an extended period of time. It may also be advantageous, during development, to test the device with “corner cases” including uncommon scenarios (e.g., high heart rates), and such testing may be hazardous to a live test subject. As such a chest emulator capable of artificially reproducing various breathing patterns or heartbeat patterns (or motion simultaneously emulating breathing and heartbeat) may be useful, especially during device development.

In the context of implantable medical devices (IMDs) containing motion sensors, it may also be beneficial to test the functionality of motion sensors in the operating room or at a time just prior to surgical implantation, to confirm that motion sensors within the IMD were not damaged in transit from the manufacturer to the surgical theater.

One example of an IMD that may include motion sensors is an implantable pulse generator (IPG). IPGs are configured to deliver electrical stimulation to an anatomical target, such as a peripheral nerve, and may be utilized to treat a variety of medical conditions, depending on the nerve being stimulated. IPGs typically include a biocompatible case that houses stimulation circuitry, and an electrode lead (such as a nerve cuff) may be operably coupled to the stimulation circuitry to transmit electrical pulses from the circuitry to the nerve. Depending on the implementation, one or more motion sensors could be provided within or on the case, or a motion sensor could be carried by the electrode lead. In any case, such sensors may be used to monitor patient health, verify treatment efficacy, or to detect biomarkers, such as changes in heart rate or respiration. Detection of a biomarker may be used as a trigger to start, stop, or otherwise modulate a parameter of stimulation, in certain implementations. Accordingly, for at least some IPGs, motion sensors may be verified to function properly prior to device implantation.

As such, in some embodiments, a chest motion emulator is used to move a device under test (DUT) in a prescribed manner, so that the performance of the device under test may be assessed or characterized. In at least one implementation, the DUT may comprise an implantable pulse generator (IPG).

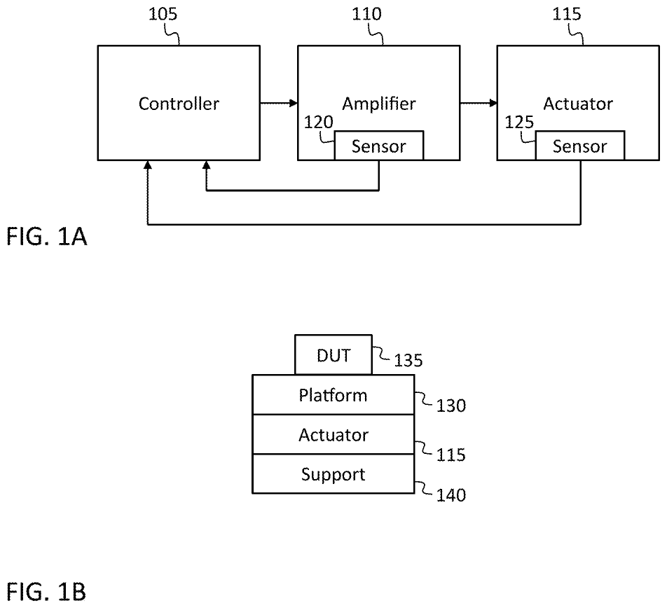

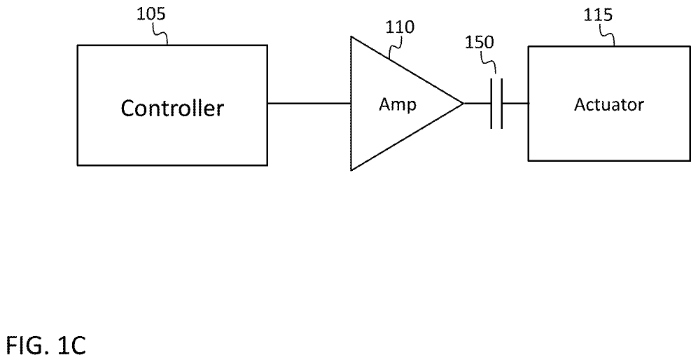

FIG. 1A is an electrical block diagram of a chest motion emulator, in some embodiments. A controller 105 (which may include a processing circuit) generates, at its output, an analog control signal which is transmitted to an amplifier 110 (e.g., a power amplifier, or “drive amplifier”), which generates a drive signal for an actuator 115. As such, the combination of the controller 105 and the amplifier 110 may be a drive circuit for the actuator 115. The amplifier 110 may include an amplifier sensor 120 for measuring an output quantity (e.g., an output voltage or an output current) of the amplifier 110. As used herein, a “sensor” may measure more than one quantity; for example, the amplifier sensor 120 may include a current sensor for measuring the output current of the amplifier 110 and a voltage sensor for measuring the output voltage of the amplifier 110. The actuator 115 may include, or be equipped with, an actuator sensor 125 which may be used to measure the motion (e.g., the (translational) position, velocity, or acceleration, or the angular position, velocity, or acceleration) of one or more points on the actuator (e.g., points on a platform 130 (FIG. 1B) for securing the device under test 135). The sensor or sensors of the actuator sensor 125 may include, for example, an accelerometer, a gyroscope, an optical sensor, a magnetic sensor, or a video camera for visual monitoring of the position or orientation of the platform 130 or of the device under test 135.

As mentioned above, a platform 130 may be part of, or secured to, the actuator 115, and may support or secure the device under test 135, as shown in FIG. 1B. The platform may be or include a mounting bracket, or a mounting plate, or one or more threaded fasteners (e.g., secured to a mounting bracket, or to a mounting plate, or directly to the actuator 115) or one or more through holes (e.g. in a mounting bracket, or in a mounting plate, or directly in the actuator 115), which may be used to attach (or “secure”) the device under test 135 to the actuator 115. In embodiments in which the actuator 115 is a loudspeaker (e.g., a subwoofer, as discussed in further detail below), the loudspeaker may have a cone with a flat region at the center of the cone. This flat region may be used as part of the platform. The device under test 135 may be secured to the flat region with threaded fasteners, each of which may extend through a mounting hole in the flat portion of the cone.

The controller 105 may be or include a computer or a microcontroller with an analog output. For example, the controller 105 may include a microcontroller including a digital to analog converter, or a general-purpose computer (e.g., a laptop computer) with an analog output (which may be the output, for example, of an integrated, direct-circuit coupled (DC-coupled) sound card, or of a Universal Serial Bus (USB) connected digital to analog converter that may have the same frequency range as the amplifier 110).

The analog control signal may include components corresponding to the heartbeat or respiration of a subject with which the device may be used. As such, it may be advantageous for the analog control signal to include frequency components ranging from the respiration rate (which may be as low as, e.g., 0.1 Hz) to the highest harmonic of interest of motion associated with the heartbeat, which may be, e.g., at 30 Hz. As such, the combination of the amplifier 110 and the actuator 115 may have a passband including at least a frequency range extending from 1 Hz to 5 Hz (e.g., a passband including a frequency range extending from 0.1 Hz to 5 Hz, or a passband including a frequency range extending from 0.1 Hz to 5 kHz). As used herein, a “passband” is a range of frequencies such that at all frequencies within the range the frequency response has a magnitude that is no less than the maximum magnitude of the frequency response, within the range, less 6 dB.

The amplifier 110 may be or include a DC-coupled amplifier (e.g., a DC-coupled class A amplifier, a DC-coupled class B amplifier, a DC-coupled class A/B amplifier, or a DC-coupled class D amplifier). In some embodiments, the amplifier 110 is not DC coupled, or is combined with a DC-blocking element, as discussed in further detail below. The amplifier 110 may be powered by a dual power supply and may have zero voltage bias at the output.

The actuator 115 may be an electrically-driven linear actuator, such as a voice coil actuator (e.g., a loudspeaker, such as a subwoofer, or (e.g., for emulating motion at higher frequencies, e.g., frequencies up to 5 kHz), a loudspeaker having a frequency response extending to higher frequencies than frequencies within the range of a subwoofer). As used herein, a “linear” actuator is an actuator that produces, as its (mechanical) output, translational motion (as opposed to rotary motion) in response to an electrical drive signal. As such, a linear actuator may be a linear motor (e.g., a voice coil actuator (as mentioned above), or an electromagnetic actuator with a geometry different from that of a voice coil actuator), or a rotary motor coupled to a suitable mechanism (e.g., a lead screw) for converting the rotational motion of the motor output shaft to translational motion.

The linear actuator may be a position actuator, such as a voice coil actuator. As used herein, a “position” actuator (as opposed to a velocity actuator) is an actuator that at low frequencies has a position proportional to the drive signal (unlike some actuators (e.g., a rotary motor coupled to a suitable mechanism for converting the rotational motion of the motor output shaft to translational motion) which may have a velocity proportional to the drive signal). As used herein, a voice coil actuator is an actuator including a cylindrical coil of wire in a gap of a cylindrically symmetrical magnet, the magnetic field in the gap being generally radial.

The controller 105 may be configured to cause (by supplying a suitable analog control signal to the amplifier 110) the actuator 115 to produce motion following a target motion profile. The target motion profile may represent the desired position, as a function of time, of the device under test 135. The target motion profile may be represented, e.g., by an array of values, each value of the array specifying a position at a corresponding point in time. The target motion profile may be selected to include a heartbeat signal, or a breathing signal, or a noise signal, each of which may be selected to emulate a corresponding motion component that may be expected to be present when a motion-sensing device is used with a live subject (e.g., to measure the heart rate or respiration rate of the subject). The noise signal may include a noise motion signal or other noise (e.g., wind noise or noise caused by motion of a subject's clothing against the device under test 135). The “noise motion signal” may include any subject motion that may be present (when the device under test 135 is used with a subject) in addition to the signal or signals (e.g., breathing and heartbeat signals) that the device under test 135 is designed to sense. As such, the noise motion signal may include non-breathing skeletal muscle motion (e.g., singultus, or motion corresponding to movements of the subject such as walking or running, or changes in position if a subject is seated or lying down) or digestive motion (motion associated with digestion). Other noise may include, e.g., wind noise or noise caused by motion of a subject's clothing against the device under test 135.

The target motion profile may be generated in any of several ways. For example, a subject (e.g., a volunteer) may be equipped with a motion sensor (e.g., strapped or otherwise secured to the chest of the subject) and the target motion profile may be recorded as the motion sensor senses the motion of the chest of the subject due to the subject's heartbeat and breathing, and due to other sources of motion such as subject motion or noise. This recorded signal may be saved in the controller 105 (e.g., stored in memory in, or connected to, or in communication with, the controller) and used as the target motion profile, for performing tests with the device under test 135. In some embodiments, such a recorded signal (or one or more similar heartbeat or breathing signals obtained otherwise, e.g., from a database of medical information, or from a computational model of human biomechanics (e.g. “OpenSim”)) may be modified to produce a target motion profile corresponding to an arbitrary heart rate or respiration rate, or a target motion profile with arbitrarily large or small noise components. As such, the system may be capable of producing motion that may be difficult to obtain from a live subject, e.g., motion corresponding to a heart rate that is sufficiently high to be hazardous to the subject.

In an embodiment in which the actuator 115 is a loudspeaker, the design of the voice coil may be one that can withstand a certain drive voltage at audio frequencies without overheating, in part because the back electromotive force (back EMF) produced by the motion of the voice coil within the magnet may limit the current flowing through the voice coil, and thereby limit the power dissipated in the voice coil, and in part because motion of the cone and the suspension of the loudspeaker may increase air flow over the voice coil. A DC voltage applied to the voice coil, however, may result in (i) no back EMF and a current limited only by the resistance of the voice coil and (ii) no increase in air flow over the voice coil. In such a situation the current may be sufficiently great to damage the voice coil. As such, as shown in FIG. 1C, the amplifier 110 (which may be a DC-coupled amplifier) may be connected to the actuator 115 through a capacitor 150, which may have a capacitance of within 50% of 0.2 F.

In other embodiments, overheating of (and damage to) the voice coil may be avoided by various other systems or methods. For example, the amplifier 110 may be coupled to the actuator 115 through a transformer (with a heat sink (or an active overtemperature protection circuit, which may use a temperature sensor on the transformer to limit or shut off the amplifier current as needed) to protect the transformer from overheating). In some embodiments, the temperature of the voice coil (or a value proportional to the temperature of the voice coil) is calculated by (i) squaring an output current sensed by the amplifier sensor 120 (to form a signal proportional to the power dissipated in the voice coil) and (ii) filtering the resulting signal with a filter (e.g., a lowpass filter) that models the thermal response of the voice coil. This calculated temperature signal may then be compared to a threshold, and the output current of the amplifier may be limited (e.g., shut off) when the calculated temperature signal exceeds the threshold.

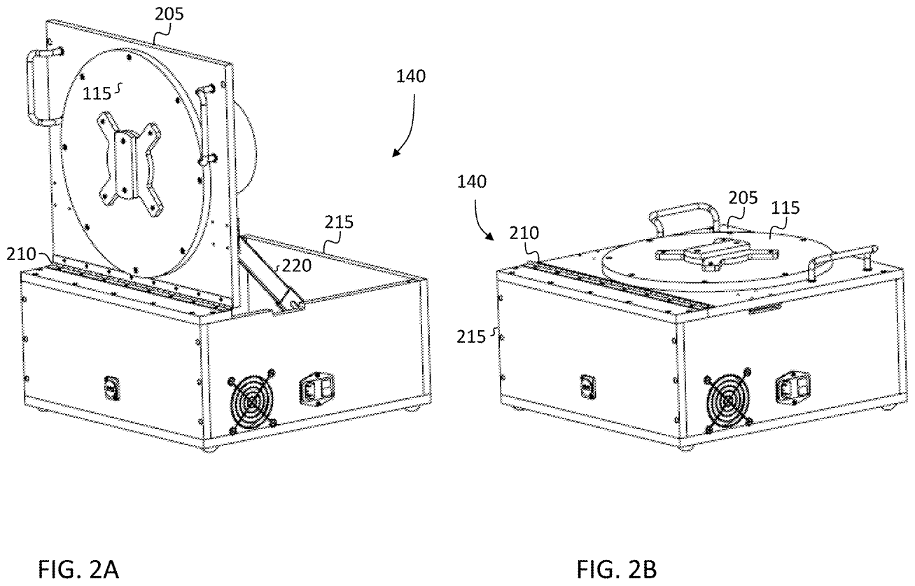

In some embodiments, the combination of the amplifier 110 and the actuator 115 provide sufficient range of motion to emulate both breathing and heartbeat. For example the range of motion may be between 0.25 inches and 3.0 inches, or more, e.g., at least 0.75 inches or at least 2.0 inches. In some embodiments, the actuator 115 is secured to a support 140, which may be used to provide stable support for the actuator, e.g., on a desk or lab bench. FIGS. 2A and 2B show an example of such a support 140, which may include an actuator plate 205 to which the actuator 115 is secured. The actuator plate 205 is attached through a hinge 210 to an enclosure 215. One or more braces 220 support the actuator plate 205 when the actuator 115 is in the horizontal position (in the position in which the direction of motion of the actuator is horizontal). FIG. 2B shows the embodiment of FIG. 2A with the actuator 115 in a vertical position (in the position in which the direction of motion of the actuator is vertical). Each of the braces 220 (of which there may be two, only one of which is visible in FIG. 2A) may be an extendable brace, e.g., a flat telescoping strut capable of being (i) locked in an extended position, to support the actuator 115 in the horizontal position or (ii) released to return to a retracted position, in which the actuator plate 205 is supported by the walls of the enclosure 215 and the actuator 115 is in the vertical position. Such an arrangement may also enable the operation of the actuator 115 in intermediate positions, between the horizontal position and the vertical position.

Various systems and methods may be employed to calibrate the system, e.g., to ensure that the motion, of the device under test 135, produced by the actuator 115, is substantially equal to the target motion profile. For example, the displacement of the actuator 115 may be measured (using a suitable sensor or measuring instrument) while the output current of the amplifier 110 is known (e.g., as a result of also being measured using a suitable sensor or measuring instrument), and the ratio of displacement to drive current may be used to scale the target motion profile. For example, in operation (after calibration has been completed) the target motion profile may be divided by the ratio of displacement to drive current (calculated from the measured displacement and the measured drive current) and the result of this division may be fed to the amplifier 110. The division may be performed digitally, before the signal is converted to analog form by the digital to analog converter. Such a method may provide sufficient accuracy if the frequency response of the combination of the amplifier 110 and the actuator 115 is sufficiently flat over the range of frequencies of interest.

In some embodiments, a frequency-dependent calibration is used, e.g., the transfer function of the combination of the amplifier 110 and the actuator 115 is measured and an inverse filter (which may be a digital discrete-time filter, e.g., an infinite impulse response (IIR) filter or a finite impulse response (FIR) filter) may be created (e.g., by fitting the filter coefficients so that the filter frequency response is approximately equal to the inverse of the measured transfer function). This filter may then be applied, e.g., in the controller 105, before the signal is converted to analog form by the digital to analog converter. Such an approach may be used to suppress the effects, for example, of a DC blocking circuit (such as the capacitor 150 of FIG. 1C) or of a resonance of the actuator 115 (e.g., in the case of an actuator that is a loudspeaker, the resonance due to (i) the moving mass of the actuator, including the mass of the device under test 135, and (ii) the restoring force of the suspension of the loudspeaker).

In some embodiments, closed-loop control of the amplifier output current or of the position (or velocity, or acceleration) of the actuator may be used to reduce discrepancies between the target motion profile and the motion of the actuator. For example, an error signal may be calculated (i) by subtracting the measured motion of the actuator from the target motion profile, or (ii) by subtracting the measured amplifier output current from an amplifier current that is calculated based on the target motion profile. Either or both of these error signals may then be fed back to the controller 105 (as shown in FIG. 1A) or to the input of the amplifier 110, or calculated by the controller 105 (and added to the signal, after filtering with a loop filter or scaling with a suitable gain).

In some embodiments, a plurality of actuators (each driven by a respective amplifier) may be combined, e.g., to cause motion of the device under test 135 in several degrees of freedom. For example, a second actuator may be secured to a platform of a first actuator, and the device under test 135 may be secured to a platform of the second actuator. In such an embodiment, if the direction of motion of the second actuator is perpendicular to the direction of motion of the first actuator, driving both actuators may result in motion, of the device under test 135, along both directions, i.e., along the two translational degrees of freedom corresponding to the directions of motion of the actuators. In other embodiments, one or more linkages, hinges, or flexures may be used to combine the motions produced by several actuators. For example, in some embodiments, the actuators are arranged in a Stewart platform (or “hexapod”) configuration and are able to produce motion, of the device under test 135, in each of its three translational degrees of freedom and in each of its three rotational degrees of freedom. In an embodiment with a plurality of actuators the position of the device under test 135 may be specified as a 6-element vector, and the target motion profile may similarly include the six degrees of freedom (3 translational degrees of freedom and 3 rotational degrees of freedom) of a rigid-body.

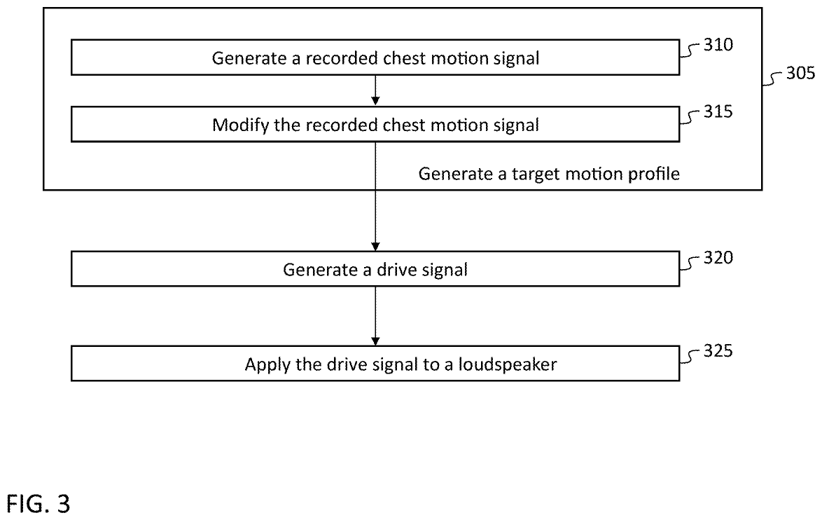

FIG. 3 is a flow chart of a method for operating a chest motion emulator including a loudspeaker, in some embodiments. The method includes generating, at 305, a target motion profile. The target motion profile may be generated as discussed above; for example, the generating of the target motion profile may include generating, at 310, a recorded chest motion signal (e.g., recording, as discussed above, a signal from a motion sensor secured to the chest of a subject), and modifying, at 315, the recorded chest motion signal (or the generating of the target motion profile may include generating (using a computational model of human biomechanics) a simulated chest motion signal, and optionally modifying the simulated chest motion signal). The modifying may include, as discussed above, modifying the recorded chest motion signal to generate a motion signal corresponding to a heart rate that is higher or lower than the heart rate of the subject was when the recording was generated.

The method may further include generating a drive signal, at 320. This drive signal may be generated, for example, by converting the target motion profile to analog form, and amplifying the resulting analog signal, as discussed above. The method may further include applying the drive signal to the loudspeaker, at 325. As discussed above, the loudspeaker may be configured to support or secure a device under test 135, so that the chest motion emulator may be used to test or characterize the response of the device under test 135 to the motion generated by the chest motion emulator.

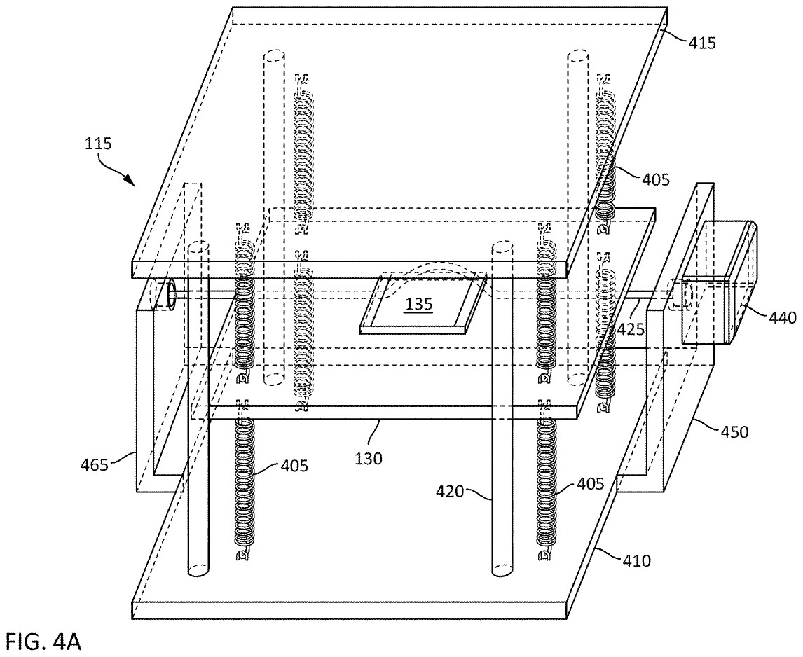

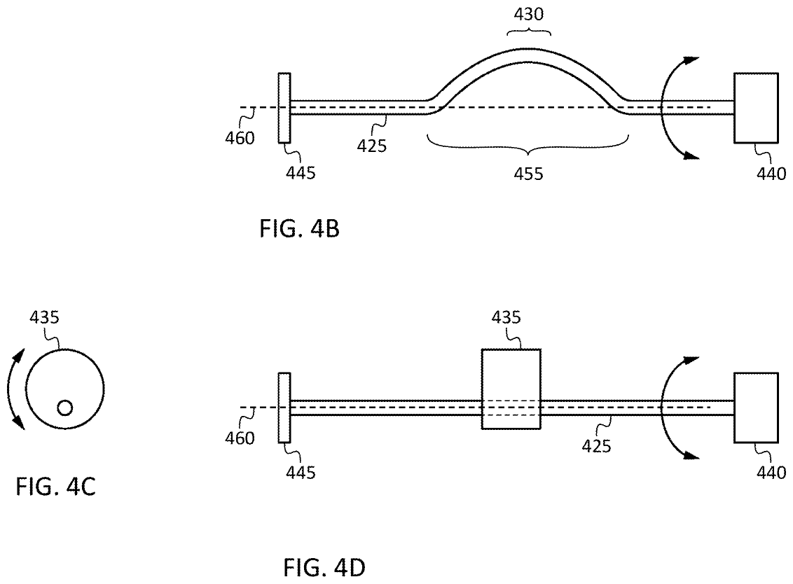

In some embodiments, the actuator 115 may be constructed as illustrated in FIG. 4A. The platform 130, to which is secured the device under test 135, may be a movable element suspended on or from springs 405 which in turn are supported from or on a frame. The frame may include a bottom plate 410, a top plate 415, and a plurality of posts 420 (e.g., four posts) that secure the bottom plate 410, and the top plate 415 together. Each of the overall dimensions of the frame (e.g., the length, the width, and the height) may be between 5 centimeters (cm) and 50 cm.

The platform may be relatively lightweight, e.g., it may weigh between 2 grams (g) and 70 g (e.g., it may weigh about 10 g). The platform may be composed of an organic polymer, e.g., a thermoplastic or a thermoset plastic. The platform may be fiber-reinforced, e.g., it may be reinforced with glass or carbon fibers. The springs 405 may act as flexible elements that allow the platform 130 to move vertically, to simulate the chest motion of a subject. In some embodiments, one or more of a different kind of flexible element (e.g., one or more flexures) are used instead of (or in addition to) springs to support the platform 130 while allowing it to move, and thereby to emulate chest motion.

In the embodiment of FIG. 4A, coil springs are used, with four springs 405 (which may be referred to as “upper springs”) connected to an upper portion (e.g., to the upper surface) of the platform 130 and four springs 405 (which may be referred to as “lower springs”) connected to a lower portion (e.g., to the lower surface) of the platform 130. The upper springs 405 and the lower springs 405 may be in tension, as in the embodiment of FIG. 4A, or one or more (or all) of the springs 405 may instead be in compression.

Motion of the platform 130 may be caused by a shaft 425 (which may be referred to as an “actuator shaft”) which extends horizontally below the platform 130 and which includes an eccentric element that is in contact with the lower surface of the platform 130. In such an embodiment, rotation of the actuator shaft 425 may cause vertical motion of the platform 130 (e.g., motion emulating chest motion of a subject). The eccentric element may be an offset portion 430 of the actuator shaft 425, as illustrated in FIG. 4B, or it may be a cam 435 on the actuator shaft 425, as illustrated in FIG. 4C (which is an end view of the actuator shaft 425, in an embodiment in which the eccentric element is a cam) and FIG. 4D (which is a side view of the actuator shaft 425, in an embodiment in which the eccentric element is a cam). In the embodiment of FIG. 4B, the actuator shaft includes a U-bend 455 which results in the offset portion 430 being offset from the axis 460 of the actuator shaft 425. The actuator shaft 425 may have a diameter of approximately 5 mm, e.g., between 4 mm and 8 mm, and it may be composed of metal, e.g., stainless steel. Each of FIG. 4A 4D is drawn to scale for a respective embodiment.

The actuator shaft 425 may be positioned such that the point of contact between the offset portion 430 of the actuator shaft 425 and the lower surface of the platform 130 is below the center of mass of the platform 130 and the device under test, so that a vertical force, applied to the platform 130 at the point of contact between the offset portion 430 of the actuator shaft 425 and the lower surface of the platform 130, results in substantially vertical translational motion, with little or no horizontal motion and little or no rotation of the platform 130.

In some embodiments, the direction of motion of the offset portion 430 of the actuator shaft 425 (or of the point on the cam 435 that contacts the lower surface of the platform 130) may be oblique to the vertical direction, e.g., if the point of contact between the offset portion 430 of the actuator shaft 425 and the lower surface of the platform 130 is not at the same height as the axis 460 of the actuator shaft 425. In such an embodiment, friction between the offset portion 430 of the actuator shaft 425 and the lower surface of the platform 130 may cause the force applied to the platform 130 to be in a direction that is not strictly vertical, e.g. this force may have a horizontal component. Such a horizontal component may cause the platform 130 to move horizontally as well as vertically, or to rotate, when the actuator shaft 425 rotates.

Lubrication, e.g., grease, may be applied at the point of contact between the offset portion 430 of the actuator shaft 425 and the lower surface of the platform 130 to reduce such friction and the horizontal forces that it may produce. In some embodiments, to reduce such friction, one or both of the surface of the offset portion 430 of the actuator shaft 425 and the lower surface of the platform 130 is coated in a low-friction material, such as polytetrafluoroethylene (PTFE). Such a coating may be used instead of, or in addition to, a lubricant.

In some embodiments, the actuator shaft 425 includes a ball bearing on the offset portion 430 of the actuator shaft 425, or on the cam, to reduce friction between the eccentric portion and the lower surface of the platform 130. The ball bearing also may make it possible, when the motor 440 is at the center of its range of motion, for the offset portion 430 of the actuator shaft 425 to be at the same height as the axis of the actuator shaft 425 without the remainder of the actuator shaft 425 contacting the lower surface of the platform 130, so that the direction of motion of the actuator shaft 425 is vertical. In such an embodiment, the offset portion 430 of the actuator shaft 425 may have a straight portion onto which the ball bearing may be placed during fabrication of the actuator shaft 425, and the actuator shaft 425 may be further assembled after the ball bearing is placed on the straight portion of the actuator shaft 425, for example by welding, or by the use of threaded fasteners or actuator shaft couplings. In some embodiments, a boss or protrusion may be present on (e.g., formed as part of, or secured to) the lower surface of the platform 130 at the point of contact between the offset portion 430 of the actuator shaft 425 and the lower surface of the platform 130. Such a boss or protrusion may cause the offset portion 430 of the actuator shaft 425 to be at the same height as the axis of the actuator shaft 425 when the motor 440 is at the center of its range of motion.

The actuator shaft 425 may be supported at one or both ends by bearings 445, e.g., ball bearings, or hinges. For example, a first end, or “proximal end” of the actuator shaft 425 may be supported by the motor 440 (through a shaft coupling, as discussed below), and a second end, or “distal end” of the actuator shaft may be supported by a bearing 445, as illustrated in FIGS. 4B and 4D. As mentioned above, one end of the actuator shaft 425 may be driven by a motor 440.

The motor 440 may be driven by a suitable drive circuit which may select it to be suitable for driving the motor 440. The motor 440 may be a galvanometer motor, which may have a limited range of motion, less than 360 degrees. In the galvanometer motor, a spring causes the motor output shaft (or “motor shaft”) to return to a default angle when current flows through the motor 440. When a current is driven through the motor 440, the angle of the motor shaft may be proportional to a current driven through the motor 440, the rotation of which may be driven by a drive circuit such as that illustrated in FIGS. 1A and 1C. As in an embodiment in which the actuator is a loudspeaker, the drive circuit for a galvanometer may drive a current through the motor 440 that is proportional to the target displacement of the platform 130.

In some embodiments, the motor 440 is a servo motor, such as an HS-645MG servo motor available from Hitec. The drive circuit for such a servo motor may supply, to the servo motor, power and a pulse-width-modulated control signal. Such a servo motor may have a limited range of motion, less than 360 degrees, and the angle of the output shaft of such a servo motor may, in operation, be proportional to the pulse width of the control signal supplied to the servo motor. In some embodiments, the motor 440 is a stepper motor (which may be driven with a micro-stepping waveform to improve the smoothness of the motion produced).

The motor 440 may be supported by a suitable bracket, e.g., a first L-bracket 450, as illustrated in FIG. 4A. The output shaft of the motor 440 may be coupled to the actuator shaft 425 by a suitable shaft coupling which may be secured both to the motor shaft and the actuator shaft 425. Such a shaft coupling, for example, may include a cylindrical part, with a bore on one end that accommodates, and is secured to, the motor shaft, and a bore on the other end which accommodates, and is secured to, the actuator shaft 425. Each end of such a shaft coupling may be secured to the respective shaft by a set screw, for example. In some embodiments, the shaft coupling includes a flange that is secured to the output shaft of the motor 440 and a flange that is secured to the actuator shaft 425. These two flanges may then be secured together, using threaded fasteners, for example. In the case of a servo motor, such a flange may be secured to the output shaft of the motor 440 by a machine screw which may extend through a hole in the flange into a threaded hole in the end of the motor output shaft. The bearing supporting the distal end of the actuator shaft 425 may be supported by a second bracket 465 (e.g., the bearing may be secured in a hole in the second bracket 465), as illustrated in FIG. 4A.

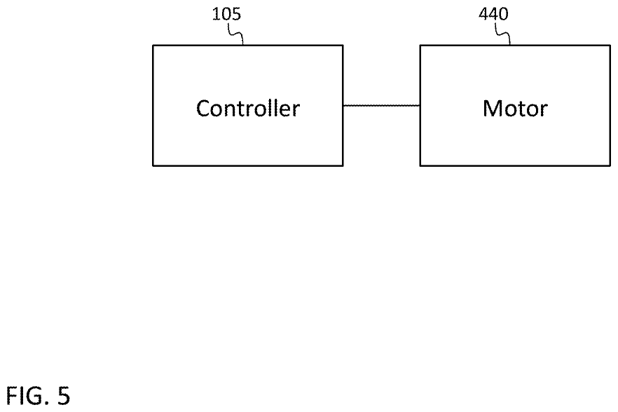

FIG. 5 shows a drive circuit for an embodiment in which the motor 440 is a servo motor. The controller may be or include a microcontroller, which may include a circuit (e.g., a timer) capable of generating the pulse-width-modulated control signal for the servo motor. The controller may be or include, for example, an ATmega328P microcontroller (available from Microchip Technology) or an Arduino Uno prototyping board containing such a microcontroller. Such a microcontroller may also perform some or all of the signal processing described herein.

In embodiments using the actuator 115 of FIG. 4A-4D, the controller 105 may be configured to supply a suitable control signal (i) to the actuator 115 (as illustrated in FIG. 5), in embodiments in which the motor 440 is a servomotor, or (ii) to the amplifier 110 (as illustrated in FIG. 1C), in embodiments in which a continuous drive signal is used, e.g., if the motor 440 is a galvanometer motor. By supplying such a drive signal, the controller 105 may cause the actuator 115 to produce motion following a target motion profile, in the same manner as described above for embodiments in which the actuator 115 is a loudspeaker. The target motion profile may be generated in the same manner as described above for embodiments in which the actuator 115 is a loudspeaker. Similar measures to those taken for an actuator that is a loudspeaker may be taken to avoid overheating in a galvanometer motor.

In some embodiments, the combination of the amplifier 110 and the actuator 115 provide sufficient range of motion, or a sufficient frequency range, to emulate chest motion due to breathing, or chest motion due to heartbeat, or both. Various systems and methods may be employed to calibrate the system, e.g., to ensure that the motion, of the device under test 135, produced by the actuator 115, is substantially equal to the target motion profile. Such calibrations may be performed in the same manner as described above for embodiments in which the actuator 115 is a loudspeaker.

In some embodiments using the actuator 115 of FIG. 4A-4D, closed-loop control of the position (or velocity, or acceleration) of the actuator may be used to reduce discrepancies between the target motion profile and the motion of the actuator, in the same manner as described above for embodiments in which the actuator 115 is a loudspeaker. For example, an error signal may be calculated as described above, and used by the controller 105 to generate the control signal or drive signal sent to the motor 440 of the actuator 115.

As used herein, “a portion of” something means “at least some of” the thing, and as such may mean less than all of, or all of, the thing. As such, “a portion of” a thing includes the entire thing as a special case, i.e., the entire thing is an example of a portion of the thing. As used herein, when a second quantity is “within Y” of a first quantity X, it means that the second quantity is at least X−Y and the second quantity is at most X+Y. As used herein, when a second number is “within Y %” of a first number, it means that the second number is at least (1−Y/100) times the first number and the second number is at most (1+Y/100) times the first number. As used herein, the word “or” is inclusive, so that, for example, “A or B” means any one of (i) A, (ii) B, and (iii) A and B.

Each of the terms “processing circuit” and “means for processing” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

Although not clearly depicted in the figures, in some implementations the system may include one or more heat dissipation components, such as a heat sink or a fan, to help regulate the temperature of (e.g., to cool) electrical components within the chest emulator, such as the amplifier 110, or heat-dissipating components of the amplifier 110, such as output transistors of the amplifier 110. In such instances, some embodiments may include one or more heat sinks (and may not include any fans) for cooling to avoid the possibility that fan motion is detectable by the motion sensor of the DUT and could unintentionally skew testing results.

As used herein, when a method (e.g., an adjustment) or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

It will be understood that when an element or layer is referred to as being “on”, “connected to”, “coupled to”, or “adjacent to” another element or layer, it may be directly on, connected to, coupled to, or adjacent to the other element or layer, or one or more intervening elements or layers may be present. In contrast, when an element or layer is referred to as being “directly on”, “directly connected to”, “directly coupled to”, or “immediately adjacent to” another element or layer, there are no intervening elements or layers present.

Any numerical range recited herein is intended to include all sub-ranges of the same numerical precision subsumed within the recited range. For example, a range of “1.0 to 10.0” or “between 1.0 and 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Similarly, a range described as “within 35% of 10” is intended to include all subranges between (and including) the recited minimum value of 6.5 (i.e., (1−35/100) times 10) and the recited maximum value of 13.5 (i.e., (1+35/100) times 10), that is, having a minimum value equal to or greater than 6.5 and a maximum value equal to or less than 13.5, such as, for example, 7.4 to 10.6. Any maximum numerical limitation recited herein is intended to include all lower numerical limitations subsumed therein and any minimum numerical limitation recited in this specification is intended to include all higher numerical limitations subsumed therein.

It will be understood that when an element is referred to as being “directly connected” or “directly coupled” to another element, there are no intervening elements present. As used herein, “generally connected” (or “generally coupled”) means connected by an electrical path (or mechanical linkage) that may contain arbitrary intervening elements, including intervening elements the presence of which qualitatively changes the behavior of the circuit or mechanical assembly. As used herein, “connected” (or “coupled”) means (i) “directly connected” (or “directly coupled”) or (ii) connected (or coupled) with intervening elements, the intervening elements being ones (e.g., low-value resistors or inductors, or short sections of transmission line (or shaft couplings or short sections of shaft)) that do not qualitatively affect the behavior of the circuit or mechanical assembly.

Although exemplary embodiments of a chest motion emulator have been specifically described and illustrated herein, many modifications and variations will be apparent to those skilled in the art. Accordingly, it is to be understood that a chest motion emulator constructed according to principles of this disclosure may be embodied other than as specifically described herein. The invention is also defined in the following claims, and equivalents thereof.

1. A system, comprising:
a chest motion emulator, comprising:
an actuator, comprising:
a movable platform for a device under test;
a shaft having an eccentric portion; and
a motor, directly coupled to the shaft and configured to cause the shaft to turn,
the eccentric portion being configured to cause the platform to move in response to rotation of the motor.

2. The system of claim 1, wherein:
the actuator further comprises a first flexible element; and
the movable platform is supported by the first flexible element.

3.-4. (canceled)

5. The system of claim 2, wherein:
the first flexible element is a first spring, and
the actuator comprises a plurality of springs including the first spring.

6.-7. (canceled)

8. The system of claim 5, wherein:
the actuator further comprises a frame; and
each of the springs is further secured to the frame.

9. (canceled)

10. The system of claim 8, wherein the movable platform is a movable plate.

11. (canceled)

12. The system of claim 1, wherein the eccentric portion is a cam, secured to the shaft.

13. The system of claim 1, wherein the eccentric portion is an offset portion of the shaft.

14. The system of claim 1, wherein the chest motion emulator further comprises a drive circuit connected to the motor.

15. The system of claim 14, wherein the combination of the drive circuit and the actuator has a passband including a frequency range extending from 0.2 Hz to 0.3 Hz.

16. The system of claim 1, wherein the motor is a servomotor.

17. The system of claim 1, wherein:
the chest motion emulator is capable of emulating chest motion of a subject, and
the chest motion comprises motion caused by breathing.

18. The system of claim 17, wherein the chest motion further comprises motion caused by a heartbeat.

19. The system of claim 17, wherein the chest motion further comprises noise motion.

20.-21. (canceled)

22. The system of claim 1, wherein the device under test is an implantable pulse generator.

23. A method, comprising:
generating emulated motion, by a chest motion emulator, the emulated motion emulating chest motion of a subject,
the chest motion emulator comprising:
an actuator, comprising:
a movable platform for a device under test;
a shaft having an eccentric portion; and
a motor, directly coupled to the shaft and configured to cause the shaft to turn,
the eccentric portion being configured to cause the platform to move in response to rotation of the motor.

24. The method of claim 23, wherein the chest motion comprises motion caused by breathing.

25. The method of claim 23, wherein the chest motion further comprises motion caused by a heartbeat.

26. The method of claim 23, wherein the chest motion further comprises noise motion.

27.-28. (canceled)

29. The method of claim 23, wherein the generating of the emulated motion comprises:
generating a target motion profile;
generating a drive signal based on the target motion profile; and
applying the drive signal to the actuator.

30. The method of claim 29, wherein the generating of the target motion profile comprises:
generating a recorded chest motion signal by recording a signal from a motion sensor secured to the chest of a subject; and
modifying the recorded chest motion signal.
